(19) United States
(12) Patent Application Publication
(10) Pub. No.: US 2004/0099579 A1
(43) Pub. Date: May 27, 2004

(54) Sliding gate sorting apparatus and method for sorting using a sliding gate

(76) Inventor: Leslie Thomas, West Bloomfield, MI (US)

Correspondence Address: KENYON & KENYON, ONE BROADWAY, NEW YORK, NY, 10004, US

(21) Appl. No.: 10/303,143

(22) Filed: Nov. 22, 2002

(51) Int. Cl. B07C 5/00; A01K 43/04

(52) U.S. Cl. 209/510; 209/576

(57) ABSTRACT

A system for sorting articles includes a conveyor transporting the articles in conveying zones. An identifier directed at an identification zone on the conveyor identifies an article bearing a particular characteristic. A sliding gate coupled to the conveyor at a removal zone on the conveyor downstream from the identification zone is arranged below the articles and controlled by the identifier to open when the article bearing the characteristic passes the removal zone. The sliding gate opens parallel to the conveyor and either in the conveyor direction or the direction opposing the conveyor direction. The sliding gate provides an opening of the same length as the conveying zone. A device for sorting articles includes a sliding gate on the conveyor at a removal zone. The sliding gate is arranged below the articles and controlled by an identifier to open when an article bearing a characteristic passes the removal zone. The identifier is directed at an identification zone on the conveyor and is able to identify the article bearing a characteristic at the identification zone. A method for sorting articles includes conveying the articles and identifying an article bearing a characteristic at an identification zone. The method also includes separating the article bearing the characteristic from the articles not bearing the characteristic by a sliding gate. The sliding gate is coupled to the conveyor at a removal zone downstream from the identification zone. The sliding gate is controlled by an identifier and opens when the article bearing the characteristic passes the removal zone.

### FIELD OF THE INVENTION

The present invention relates to a sorting apparatus and to a sorting method.

### BACKGROUND INFORMATION

Sorters for sorting various items including sorters for separating broken shell eggs and dirty shell eggs from unbroken, clean shell eggs utilizing trapdoor mechanisms are conventional. These sorters may use any of several identifying methods including vision systems, weighing systems, manual operations, or combinations thereof to identify the broken or dirty shell eggs (the discards) from the clean, unbroken shell eggs. Separation of the discards from the other eggs has been achieved by several methods, including manual and mechanical methods. Mechanical separation methods have employed trapdoor mechanisms. However, mechanical separation methods, including the use of trapdoor mechanisms, have not kept pace with the rapid increase in the speed of the processing machines. As a result, either the separation method has caused an increase in broken shell eggs due to unbroken, clean shell eggs being broken by the separation mechanism, or the processing speed has been reduced to accommodate the separation mechanism. Therefore, in order to further increase efficiency, what is needed is a fast and efficient method of separating broken or dirty shell eggs from clean, unbroken shell eggs within a high-speed processing machine.

It is an object of the present invention to provide a sorting apparatus that includes a sliding gate mechanism. It is another object of the present invention to provide a method for sorting items by a sliding gate mechanism.

### SUMMARY

The above and other beneficial objects of the present invention are achieved by providing a sorting apparatus and method as described herein. A system for sorting articles is provided which includes a conveyor transporting the articles within conveying zones. In one example embodiment of a sorting apparatus according to the present invention, within each conveying zone, only one article is conveyed. An identifier is directed at an identification zone on the conveyor and identifies an article bearing a particular characteristic at the identification zone. A sliding gate is coupled to the conveyor at a removal zone on the conveyor. The removal zone is located downstream from the identification zone. The sliding gate is arranged below the articles and is is controlled in accordance with the identifier to open when the article bearing the characteristic arrives at the removal zone. The sliding gate opens in a direction of a movement of the conveyor or in a direction opposing the movement of the conveyor. The sliding gate opens by sliding parallel to the conveyor and opens to provide an opening of approximately the same length as the conveying zone.

A device for sorting articles is provided which includes a sliding gate on the conveyor at a removal zone. The sliding gate is arranged below the articles and is controlled in accordance with an identifier to open when an article bearing a characteristic arrives at the removal zone.

A method for sorting articles is provided which includes the steps of conveying the articles and identifying an article bearing a characteristic at an identification zone. The method also includes the step of separating the article bearing the characteristic from the articles not bearing the characteristic by a sliding gate. The sliding gate is coupled to the conveyor downstream from the identification zone. The method further includes the steps of controlling the sliding gate in accordance with an identifier and opening the sliding gate when the article bearing the characteristic arrives at the removal zone.

### BRIEF DESCRIPTION OF THE DRAWINGS

FIG. 1 is a schematic view of a conveying apparatus including a shell egg sorter according to an example embodiment of the present invention.

FIG. 2 is a cross-sectional view of the conveying apparatus according to the example embodiment of the present invention shown in FIG. 1.

FIG. 3 is a flow chart illustrating a method of sorting items according to an example embodiment of the present invention.

FIG. 4 is a schematic view of a conveying apparatus including a shell egg sorter according to another example embodiment of the present invention.

### DETAILED DESCRIPTION

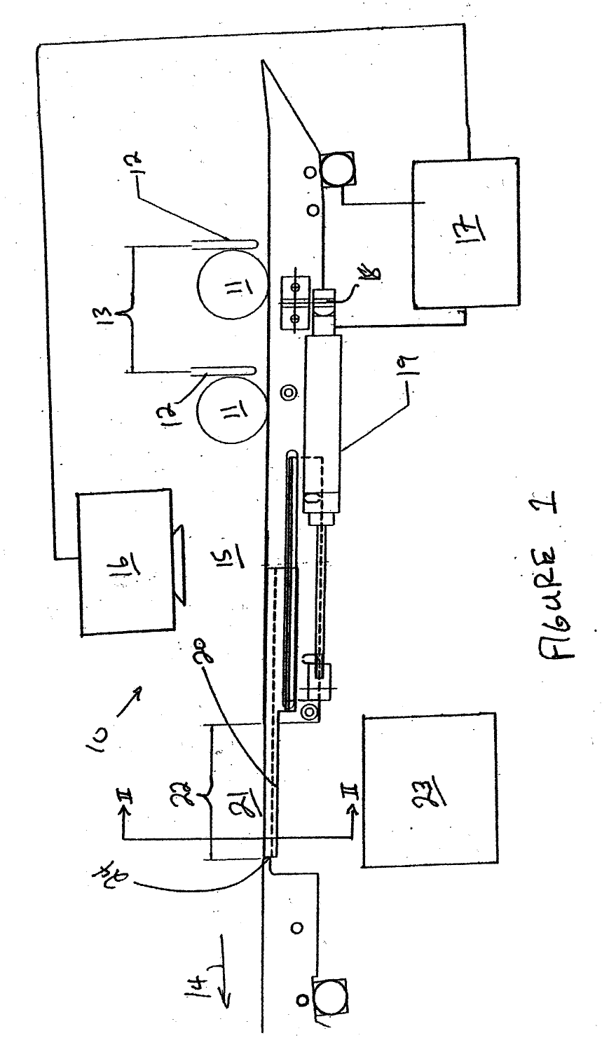

FIG. 1 is a schematic view of a shell egg sorter according to an example embodiment of the present invention. Articles 11 are conveyed along the conveying apparatus 10 by pusher pins 12. Alternatively to pusher pins 12, paddles, depressions, etc., or other devices configured to move, direct and/or control the position and movement of an article may be provided to convey articles 11 along conveying apparatus 10. Pusher pins 12 are separated by a distance 13, which defines the spacing between articles 11 along conveying apparatus 10. The space defined by distance 13 is also referred to as the conveying zone, which describes the area in which a single article 11 is conveyed. Pusher pins 12 are regularly spaced and continuous along the conveying apparatus 10 to continue propelling articles 11 along conveying apparatus 10 in the direction of arrow 14. For clarity, only two pusher pins 12 and two articles 11 are illustrated in FIG. 1.

Each conveying zone passes identification zone 15 on conveying apparatus 10. Identification zone 15 is a position on conveying apparatus 10 arranged under identification system 16. Identification system 16 may produce an image of article 11 in the particular conveying zone and may communicate the image to control system 17. Control system 17 may include any number of different computer systems executing an identification program designed to identify a specific characteristic of article 11. This characteristic may indicate any number of specific characteristics, e.g., dirty shells, broken shells, etc. Alternatively, identification system 16 may include an infrared system, an ultraviolet imaging system, an x-ray imaging system, any other type of sensor for collecting data relating to article 11, etc.

Control system 17 is connected to actuator 18, which controls the operation of cylinder 19. Cylinder 19 opens and closes sliding gate 20. Sliding gate 20 moves in a direction parallel to the direction of motion of conveying apparatus 10, and in the example embodiment shown opens against the direction of arrow 14. Alternatively, sliding gate 20 may open in a direction opposing arrow 14. Sliding gate 20 may be moved by any device configured to move in accordance with a signal from control system 17. Such devices for moving sliding gate 20 include, e.g., pneumatic cylinders, hydraulic cylinders, electric motors, magnets, electric solenoids, linear motors, etc. Control system 17 may be electrically coupled to conveying apparatus 10 so that control system 17 has as an input the speed of conveying apparatus 10 and may therefore calculate the time that each article 11 having the identified characteristic (e.g., a broken shell or a dirty shell) identified by identification system 16 passing through identification zone 15 will arrive at removal zone 21. Removal zone 21 refers to the area over sliding gate 20, and therefore removal zone 21 indicates the area in which articles 11 with the identified characteristic may be separated from articles 11 without the identified characteristic. In this manner, control system 17 is able to actuate actuator 18 to control cylinder 19 to open sliding gate 20 at the time that article 11 with the identified characteristic arrives (enters) at removal zone 21.

Removal zone 21 may correspond to distance 22 parallel to the direction of arrow 14. Distance 22 may also correspond to the amount that sliding gate 20 opens to allow the passage of article 11 from conveying apparatus 10 to recovery unit 23. Distance 22 may also correspond to the distance between pusher pins 12, i.e., may be equal to the length of a conveying zone. Sliding gate 20 is configured to open in accordance with the operation of cylinder 19. Cylinder 19 may have a stroke equal to distance 22.

When the article 11 having the characteristic arrives at removal zone 21, control system 17 sends a signal to actuator 18. Actuator 18 operates cylinder 19 which may be arranged to control sliding gate 20 by any of several possible arrangements. In one arrangement for controlling sliding gate 20, a spring acts upon sliding gate 20 so that sliding gate 20 is in a normally-closed position (i.e., sliding gate 20 spans removal zone 21 and does not select out articles 11 having the characteristic) when not acted upon by cylinder 19. Actuating actuator 18 in this example embodiment opens a valve which connects a source of pressurized air to cylinder 19. Pressurized air entering and filling cylinder 19 causes a piston to move which is connected to sliding gate 20. The movement of the piston causes sliding gate 20 to open because the force of the pressurized air in cylinder 19 against the piston is greater than the force of the spring holding sliding gate 20 closed. After the conveying zone carrying the article 11 having the characteristic has passed the removal zone 21, control system 17 may send a second signal to actuator 18. In response to the second signal, actuator 18 may operate a valve to open and release the air from cylinder 19, thereby causing sliding gate 20 to close at the urging of the spring. The valve may be operated to either slowly release the air from cylinder 19 or quickly release the air or may be configured to release the air at a variable rate, the rate being chosen, e.g., based on the speed of conveying apparatus 10. The intake of air into cylinder 19 to open sliding gate 20 may be via a valve that either operates at a predetermined speed or at a variable speed, which may be a function of the speed of conveying apparatus 10.

In one example embodiment, control system 17 sends a signal to actuator 18 to open the valve to let pressurized air into cylinder 19 at the moment that the trailing edge of the conveying zone carrying article 11 bearing the characteristic contacts removal zone 21. Cylinder 19 is thereby charged with air and causes sliding gate 20 to open in a direction opposite to arrow 14 for distance 22 at a high rate of speed relative to the speed of the conveying apparatus. Therefore, sliding gate 20 is completely open for the particular conveying zone, and article 11 in the conveying zone falls through the opening created by sliding gate 20 and into recovery unit 23. In this example embodiment, immediately after reaching a fully open position, control system 17 provides a “close” signal to actuator 18. In response to the close signal, actuator 18 opens a release valve to an amount determined by control system 17, e.g., based on the speed of conveying apparatus 10. The release valve releases the pressurized air from cylinder 19, thereby causing the force from the spring to close the sliding gate 20. The valve may be configured to release air from cylinder 19 at a rate that causes sliding gate 20 to close at or about the same speed as the speed of movement of conveying apparatus 10. In this manner, sliding gate 20 is not open when the next conveying zone is at the removal zone. The process is ready to repeat when subsequent articles 11 bearing the characteristic pass into removal zone 21.

In another example embodiment, sliding gate 20 is configured to open in the direction of arrow 14. In this example embodiment, sliding gate 20 may open at a variable rate dependent, e.g., on the speed of conveying apparatus 10. Control system 17 may control actuator 18 to open a variable opening valve to pressurized air to flow from a source (e.g., a reservoir, a compressor, etc.) into cylinder 19 at the moment that the leading edge of the conveying zone having article 11 bearing the characteristic contacts removal zone 21. The variable opening valve may be opened to the extent necessary to have sliding gate 20 open at the same speed as the speed of conveying apparatus 10. The opening defined by sliding gate 20 may be commensurate with the interaction of the conveying zone having article 11 bearing the characteristic and removal zone 21. When sliding gate 20 is fully opened in this example embodiment, the conveying zone is superimposed on removal zone 21. Upon sliding gate 20 reaching a full, open position, control system 17 may control actuator 18 to open a release valve which may quickly discharge the pressurized air from cylinder 19 causing the spring on sliding gate 20 to urge sliding gate 20 closed. In this manner, article 11 in the next conveying zone may not fall through the opening defined by sliding gate 20.

As indicated above, sliding gate 20 may open either in the direction of arrow 14 or opposite the direction of arrow 14. Sliding gate 20 may open at the urging of an air cylinder, electric motor, electric solenoid, magnet, mechanical spring, a system connecting sliding gate 20 to conveying apparatus 10, and/or any other arrangement configured to open a gate, etc. Additionally, sliding gate 20 may be urged to close by any of the above-mentioned arrangements. Additionally, any combination of the above-mentioned arrangements may be used to open sliding gate 20, while any other combination of the above-mentioned arrangements may be used to close sliding gate 20. Sliding gate 20 may be urged open or closed at a high rate of speed and may be urged open or closed at the same rate of speed as conveying apparatus 10.

Article 11 in removal zone 21 falls through the opening provided by sliding gate 20 and falls into recovery unit 23. Recovery unit 23 may be a final discard area, a through-point to a final discard area, a washing device, a combination of the above, etc. Alternatively, recovery unit 23 may include further identifying arrangements for distinguishing between dirty shell eggs and broken shell eggs, or for distinguishing between different identifiable characteristics of articles 11. If recovery unit 23 includes a washing device for washing dirty eggs, then recovery unit 23 may also include a conveying arrangement for returning the cleaned eggs to conveying apparatus 10 at a point before identification zone 15 (i.e., at a predetermined distance from identification system 16 in a direction opposite to arrow 14).

Sliding gate 20 may be configured to open at the moment that article 11 passes into removal zone 21 and to close at the same speed as the speed of conveying apparatus 10 (i.e., the same speed as pusher pins 12). Proper coordination of the speed of conveying apparatus 10 and the open signal transmitted by control system 17 to actuator 18 may enable removal zone 21 to be commensurate with the conveying zone carrying article 11 bearing the characteristic. Further, proper coordination may provide that leading edge 24 of sliding gate 20 closes so that leading edge 24 may move to the closed position as pusher pin 12 defining the leading edge of the next conveying zone passes through removal zone 21. That is, sliding gate 20 closes as the next conveying zone, including the next article 11, passes over sliding gate 20.

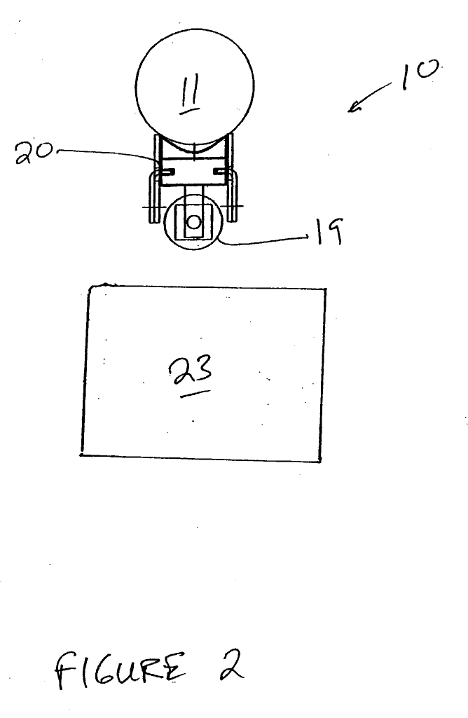

FIG. 2 is cross-sectional view of the example embodiment illustrated in FIG. 1 taken along line II-II of FIG. 1. FIG. 2 illustrates article 11 arranged on top of sliding gate 20, which is arranged above and connected to cylinder 19. Article 11 is on sliding gate 20 when sliding gate 20 is not retracted from removal zone 21. Therefore, when cylinder 19 is actuated to open sliding gate 20, article 11 in removal zone 21 is no longer supported and falls off conveying apparatus 10 into recovery unit 23.

The system according to the present invention may be ganged to provide parallel processing of articles to increase production capacity. Multiple conveying apparatuses 10 may be arranged parallel to each other. These parallel conveying apparatuses may be arranged adjacent to and on each side of conveying apparatus 10 illustrated in FIG. 2. These parallel conveying apparatuses may process other articles 11 simultaneous to article 11 illustrated in FIG. 2. Conveying apparatuses 10 may be coupled to provide a single speed and to reduce mechanical complexity and cost. Each parallel conveying apparatus 10 may have an individually controllable sliding gate 20 to allow separation of articles 11 on one conveying apparatus 10 without requiring unnecessary separations of articles 11 on parallel conveying apparatuses 10. Parallel processing of articles 11 may involve separate or combined identification systems 16 and may involve separate or combined control systems 17.

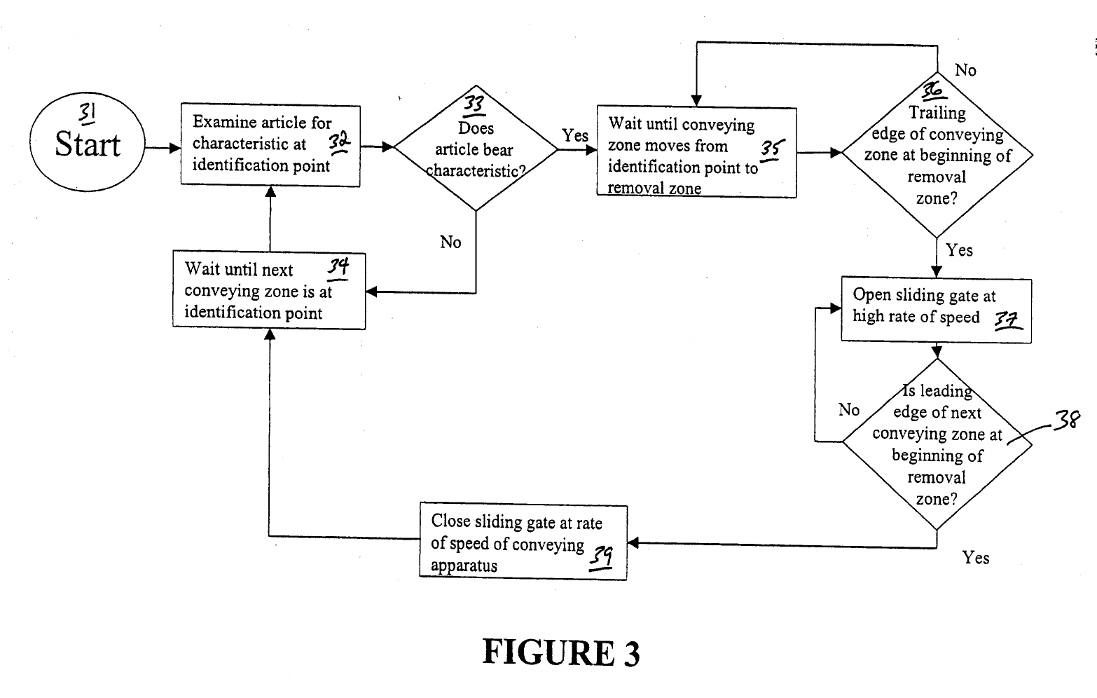

FIG. 3 is a flowchart illustrating an example embodiment of a method according to the present invention. The method starts at step 31 and proceeds to step 32, in which the article is examined for the characteristic at the identification zone. As indicated above, the article may be, e.g., a shell egg, and the characteristic may include, e.g., a dirty shell, a broken shell, or another visible or otherwise sensible characteristic of a shell egg, etc. Alternatively, the article may be any other type of article that is examined for a particular characteristic that is measurable for the purpose of separating out articles bearing a certain characteristic from articles not bearing that characteristic. From step 32, the method proceeds to step 33, in which it is determined whether the article bears the characteristic. If the article does not bear the characteristic, then the flow proceeds to step 34, in which it is waited until the next conveying zone is at the identification zone. After the waiting of step 34, control returns to step 32. If it is determined in step 33 that the article 11 includes the characteristic, control proceeds to step 35, in which it is waited until the conveying zone moves from the identification zone to the removal zone. The duration of this waiting may be determined by the control system described above. This determination may be based on the known, fixed distance between the vision system, or other identification system, used at the identification zone and the removal zone. The removal zone, as described above is the area in which the sliding gate is arranged under the articles as they pass through the removal zone. The control system may also account for the speed of the conveying apparatus, which may vary according to production requirements and other processing equipment. As such, the control system may have an input for sensing the speed of the conveying apparatus. A proximity sensor, infrared sensor, vision sensor, detector may be configured to signal to control system 17 the arrival of the article at the removal zone.

From step 35, control proceeds to step 36, in which it is determined whether the trailing edge of the conveying zone is at the removal zone. That is, in step 36, it is determined whether the article bearing the characteristic is at the removal zone. If it is determined in step 36 that the trailing edge is not at the removal zone, the control proceeds back to step 35, in which it is waited until the conveying zone moves from the identification zone to the removal zone. If it is determined in step 36 that the trailing edge is at the removal zone, the control proceeds to step 37, in which the sliding gate is opened, e.g., at a high speed relative to the speed of the conveying apparatus. This method may be appropriate for those systems in which the sliding gate opens against the direction of the flow of the conveying apparatus. In this manner, the sliding gate may open at a very high speed and would therefore very quickly be fully open while the conveying zone carrying the article bearing the characteristic is within the removal zone. Opening the sliding gate causes the article in the conveying zone to drop from the conveying apparatus. After leaving the conveying apparatus, the article may be directed to a discard bin, a washing area, a further examination apparatus to determined whether to discard or further process the article, etc.

From step 37, control proceeds to step 38, in which it is determined whether the leading edge of the next conveying zone is at the beginning of the removal zone. This determines if it is time to start closing the sliding gate. When the leading edge of the next conveying zone is at the removal zone, then the sliding gate is closed. This avoids loss or misplacement of an article by leaving the sliding gate open while an article without the characteristic passes through the removal zone. If it is determined in step 38 that the leading edge of the next conveying zone is not at the beginning of the removal zone, then control proceeds back to step 37 where an open sliding gate is indicated. However, if it is determined in step 38 that the leading edge of the next conveying zone is at the beginning of the removal zone, then control proceeds to step 39, where the sliding gate is closed at the speed of the conveying apparatus. By closing the sliding gate at the same speed as the conveying apparatus, the next conveying zone may encounter a closed sliding gate. Therefore, accidental or inadvertent loss of articles not bearing the characteristic may be prevented. From step 39, control proceeds to step 34, in which it is waited until the next conveying zone is at the identification zone.

The above-described method may work if the removal zone is adjacent to, or very close to, the identification zone. Alternatively, the method may be simultaneously conducted on different articles in different conveying zones. In other words, after one article is examined in step 32 and the flow proceeds to step 33, the method may start again with another article being examined in step 32. Therefore, the flow may proceed with different articles at different points on the conveying apparatus and at different points in the flow of the method.

The sliding gate is operated in one example embodiment by a cylinder of pressurized air. Alternatively, the cylinder may contain any other pressurized gas or fluid. The sliding gate is operable to slide parallel to the direction of movement of the article. In this manner, it may more efficiently open and close, resulting in fewer inadvertent selections of articles not bearing the characteristic and/or fewer breakages or disturbances to articles not being selected. The sliding gate may open either in the direction of the flow of the articles on the conveying apparatus, or alternatively, in the direction opposite to the flow of the articles. In the case in which the sliding gate opens in the direction of the flow of the articles, the sliding gate may open as the leading edge of the conveying zone with the article to be selected enters the removal zone. The sliding gate may in this example embodiment open at the same speed as the speed of the conveying apparatus. Therefore, the opening edge of the sliding gate may remain aligned with the leading edge of the conveying zone carrying the article bearing the characteristic. When the leading edge of this conveying zone moves to the end of the removal zone, and the sliding gate is fully open, the sliding gate is closed at a high speed relative to the speed of the conveying apparatus. In this manner, the sliding gate is fully closed when the next conveying zone enters the removal zone, and therefore, inadvertent loss of articles not bearing the characteristic may be prevented.

Alternatively, in the case in which the sliding gate opens against the direction of the flow of the articles, the sliding gate may open as the trailing edge of the conveying zone with the article to be selected enters the removal zone. The sliding gate may in this example embodiment open at a high speed relative to the speed of the conveying apparatus. When fully open, the article bearing the characteristic falls through the sliding door into the recovery unit. Thereafter, the edge of the sliding gate may close at the same rate of speed as the conveying apparatus. In this manner, the leading edge of the sliding gate may remain aligned with the trailing edge of the conveying zone carrying the article bearing the characteristic. In this manner, the sliding gate is fully closed when the next conveying zone enters the removal zone, and therefore, inadvertent loss of articles not bearing the characteristic may be prevented.

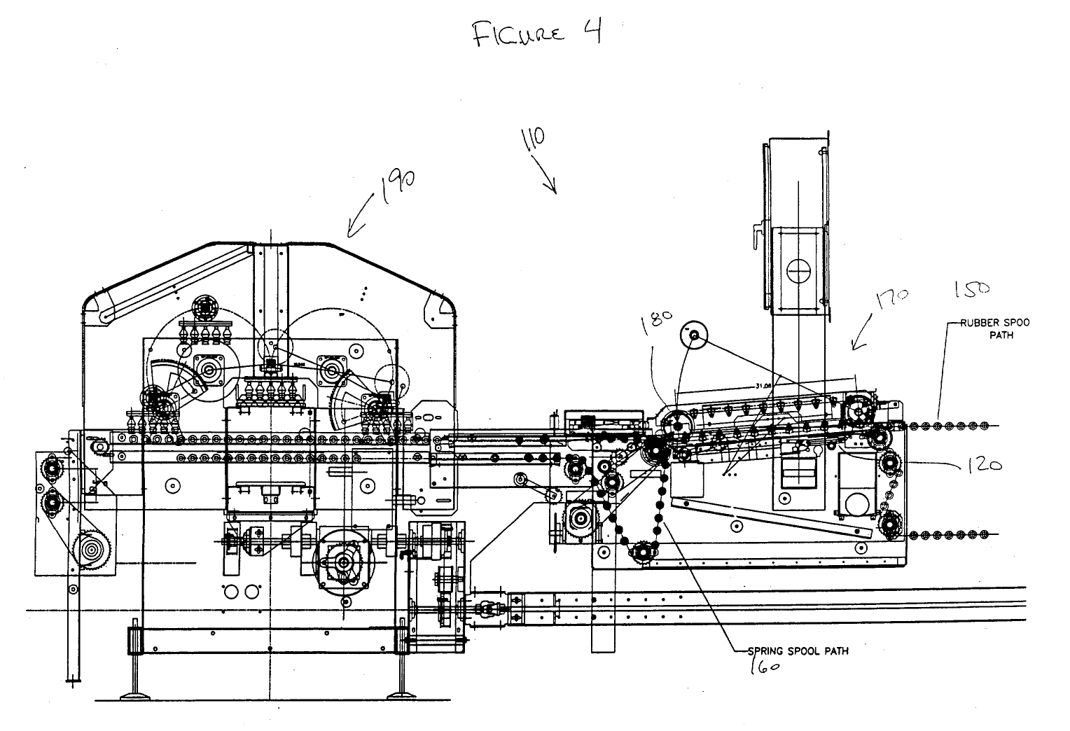

FIG. 4 is a schematic view of a conveying apparatus 110 including a shell egg sorter according to an example embodiment of the present invention. As illustrated in FIG. 4, the conveying apparatus 110 includes a rubber spool path 150 and a spring spool path 160 with a sliding gate mechanism 170 arranged therebetween. An intermediate conveyor device 180 is also arranged between the rubber spool path 150 and the spring spool path 160 to transport articles between the rubber spool path 150 and the spring spool path 160 and past the sliding gate 120. Further included in the conveying apparatus 110 may be a packer, sorter, grader, etc. unit 190. It should be appreciated that the sliding gate 120 may be arranged so that articles passing through the sliding gate 120 may be selectively washed and/or further processed and returned to, e.g., the rubber spool path after washing and/or further processing and/or may be selectively discarded. The intermediate conveyor device 180 may be arranged so that a single article is arranged above the sliding gate 120, or over each one of a gang of sliding gates 120 if the apparatus includes a gang of sliding gates 120. As more fully set forth above, the driving speed of the intermediate conveyor device 180 and/or the opening and closing speeds of the sliding gate 120 may be provided so that the sliding gate 120 reaches its closed position before a trailing article is disposed above the sliding gate 120 or may be provided so that the sliding gate 120 travels at approximately the same speed as, or, e.g., slightly faster than, the closing speed of the sliding gate 120. It should be appreciated that the sliding gate mechanism 170 and intermediate conveyor 180 are arranged as a transfer arrangement to transfer articles from and to the rubber spool path 150 and the spring spool path 160. Thus, any articles not removed by the sliding gate mechanism 170 are further processed by the second of the rubber spool path 150 and the spring spool path 160. For example, the articles are transferred from one of the rubber spool path 150 and the spring spool path 160 to a detector, e.g., a crack detector. Any undesirable articles are removed at the sliding gate 120 of the sliding gate mechanism 170, and the remaining articles are transferred onto the second one of the rubber spool path 150 and the spring spool path 160.

What is claimed is:

1. A system for sorting a plurality of articles, comprising:
a conveying apparatus adapted to transport each of the articles in a respective conveying zone in a conveying direction; and
a sliding gate mechanism arranged at a removal zone of the conveying apparatus, the sliding gate mechanism including a sliding gate adapted to slidably move in a direction substantially parallel to the conveying direction between a first position and a second position, the sliding gate in the first position defining an opening in the removal zone.

2. The system according to claim 1, further comprising an identifier directable at an identification zone on the conveying apparatus and adapted to identify at least one article bearing a characteristic at the identification zone.

3. The system according to claim 2, wherein the sliding gate is adapted to move to the first position when the at least one article bearing the characteristic passes over the sliding gate to direct the at least one article bearing the characteristic off of the conveying apparatus to an alternate path.

4. The system according to claim 3, wherein the conveying apparatus includes a plurality of cylinders arranged in spaced-apart relationship with respect to one another along a line in the conveying direction, a distance between a center of two adjacent cylinders equal to a length of the conveying zone.

5. The system according to claim 4, wherein the conveying apparatus includes at least one further plurality of cylinders arranged in spaced-apart relationship with the plurality of cylinders and each other along a line perpendicular to the line in the conveying direction, the further plurality of cylinders arranged to transport at least one further plurality of articles parallel to the plurality of articles.

6. The system according to claim 3, wherein the conveying apparatus includes a plurality of paddles arranged above the conveying apparatus and extending downwardly towards a substantially smooth conveying surface, the plurality of paddles arranged in spaced-apart relationship with respect to one another along a line in the conveying direction, a distance between two adjacent paddles equal to a length of the conveying zone.

7. The system according to claim 6, wherein the conveying apparatus includes at least one further plurality of paddles arranged in spaced-apart relationship with the plurality of paddles and each other along a line perpendicular to the line in the conveying direction, the further plurality of cylinders arranged to transport at least one further plurality of articles parallel to the plurality of articles.

8. The system according to claim 3, wherein the identifier includes at least one of a vision system, a manual operator, a weighing system, an identifying apparatus and a combination thereof.

9. The system according to claim 3, wherein the identifier identifies at least one identified conveying zone arranged to convey the at least one article bearing the characteristic.

10. The system of claim 3, wherein the articles include eggs, and the characteristic includes at least one of broken shells and dirty shells.

11. The system according to claim 10, further comprising an arrangement configured to discard eggs, the characteristic including broken shells, the at least one article bearing the characteristic arranged to be delivered to the arrangement configured to discard eggs after passing through the sliding gate.

12. The system according to claim 10, further comprising an arrangement configured to wash eggs, the characteristic including dirty shells, the at least one article bearing the characteristic arranged to be delivered to the arrangement configured to wash eggs after passing through the sliding gate, the arrangement configured to wash eggs arranged to return the at least one article bearing the characteristic to the conveying apparatus at a reinsertion point after washing the at least one article bearing the characteristic, the reinsertion point in a direction opposite the conveying direction from the identification zone.

13. The system according to claim 10, wherein the identifier includes:
a video system directable at the conveying apparatus at the identification zone; and
a processor electrically coupled to the video system, the processor programmable to identify at least one of broken shells and dirty shells from a video image communicated to the processor by the video system.

14. The system according to claim 3, wherein the sliding gate is adapted to move to the second position after the at least one article bearing the characteristic passes the removal zone.

15. The system according to claim 14, wherein the sliding gate is openable in a direction opposite the conveying direction.

16. The system according to claim 14, further comprising an air pressure system coupled to the sliding gate, the sliding gate adapted to at least one of move from the first position to the second position and move from the second position to the first position at the urging of the air pressure system, the air pressure system controllable by the identifier and synchronizable with the conveying apparatus.

17. The system according to claim 16, wherein the sliding gate is openable in the conveying direction.

18. The system according to claim 17, wherein the air pressure system is adapted to move the sliding gate to the first position at a speed of the conveying apparatus.

19. The system according to claim 17, wherein the air pressure system is adapted to move the sliding gate to the second position at a high rate of speed in accordance with a speed of the conveying apparatus to prevent any article not bearing the characteristic from passing the sliding gate while the sliding gate is open.

20. The system according to claim 19, wherein the air pressure system is adapted to move the sliding gate to the first position at a high rate of speed in accordance with a speed of the conveying apparatus.

21. The system according to claim 19, wherein the air pressure system is adapted to move the sliding gate to the second position at a speed of the conveying apparatus to prevent any article not bearing the characteristic from passing the sliding gate while the sliding gate is open.

22. A device for sorting articles, comprising:
a sliding gate mechanism arrangeable at a removal zone of a conveying apparatus, the sliding gate mechanism including a sliding gate adapted to slidably move in a direction substantially parallel to a conveying direction of the conveying apparatus between a first position and a second position, the sliding gate in the first position defining an opening in the removal zone.

23. The device according to claim 22, further comprising an identifier directable at an identification zone on the conveying apparatus and adapted to identify at least one article bearing a characteristic at the identification zone.

24. The device according to claim 23, wherein the sliding gate is adapted to move to the first position when the at least one article bearing the characteristic passes over the sliding gate to direct the at least one article bearing the characteristic off of the conveying apparatus to an alternate path.

25. The device according to claim 24, wherein the articles include eggs, and the characteristic includes at least one of broken shells and dirty shells.

26. The device according to claim 25, further comprising an arrangement configured to discard eggs, the characteristic including broken shells, the at least one article bearing the characteristic arranged to be delivered to the arrangement configured to discard eggs after passing through the sliding gate.

27. The device according to claim 25, further comprising an arrangement configured to wash eggs, the characteristic including dirty shells, the at least one article bearing the characteristic arranged to be delivered to the arrangement configured to wash eggs after passing through the sliding gate, the arrangement configured to wash eggs arranged to return the at least one article bearing the characteristic to the conveying apparatus at a reinsertion point after washing the at least one article bearing the characteristic, the reinsertion point in a direction opposite the conveying direction from the identification zone.

28. The device according to claim 24, wherein the sliding gate is adapted to move to the second position after the at least one article bearing the characteristic passes the removal zone.

29. The device according to claim 28, further comprising an air pressure system coupled to the sliding gate, the sliding gate adapted to at least one of move from the first position to the second position and move from the second position to the first position at the urging of the air pressure system, the air pressure system controllable by the identifier and synchronizable with the conveying apparatus.

30. The device according to claim 29, wherein the sliding gate is arranged to open in the conveying direction.

31. The device according to claim 30, wherein the air pressure system is adapted to move the sliding gate to the first position at a speed of the conveying apparatus.

32. The device according to claim 30, wherein the air pressure system is adapted to move the sliding gate to the second position at a high rate of speed in accordance with a speed of the conveying apparatus to prevent any article not bearing the characteristic from passing the sliding gate while the sliding gate is in the first position.

33. The device according to claim 29, wherein the sliding gate is arranged to open in a direction opposite the conveying direction.

34. The device according to claim 33, wherein the air pressure system is adapted to move the sliding gate to the first position at a high rate of speed in accordance with a speed of the conveying apparatus.

35. The device according to claim 33, wherein the air pressure system is adapted to move the sliding gate to the second position at a speed of the conveying apparatus to prevent any article not bearing the characteristic from passing the sliding gate while the sliding gate is in the first position.

36. A method of sorting articles, comprising the steps of:
conveying the articles along a conveying direction; and
selectively slidably moving a sliding gate in a direction substantially parallel to the conveying direction between a first position and a second position, the sliding gate in the first position defining an opening in a removal zone to selectively remove an article conveyed to the removal zone.

37. The method according to claim 36, further comprising the step of identifying at least one article bearing a characteristic at an identification zone.

38. The method according to claim 37, further comprising moving the sliding gate to the first position when the at least one article bearing the characteristic passes over the sliding gate to direct the at least one article bearing the characteristic off of the conveying apparatus to an alternate path.

39. The method according to claim 38, wherein the identifying step includes tracking the at least one article bearing the characteristic by identifying at least one identified conveying zone conveying the at least one article bearing the characteristic.

40. The method according to claim 38, wherein the articles include eggs, and the characteristic includes at least one of broken shells and dirty shells.

41. The method according to claim 40, further comprising discarding the at least one article bearing the characteristic after the at least one article bearing the characteristic passes through the sliding gate when the characteristic is broken shells.

42. The method according to claim 40, further comprising:
washing the at least one article bearing the characteristic after the at least one article bearing the characteristic passes through the sliding gate when the characteristic is dirty shells; and
returning the at least one article bearing the characteristic to the conveying apparatus at a reinsertion point after the washing, the reinsertion point in a direction opposite the conveying direction from the identification zone.

43. The method according to claim 38, further comprising:
directing a video system at the conveying apparatus at the identification zone;
communicating by the video system a video image to a processor, the processor electrically coupled to the video system; and
identifying by the processor at least one of broken shells and dirty shells.

44. The method according to claim 38, further comprising moving the sliding gate to the second position after the at least one article bearing the characteristic passes the removal zone.

45. The method according to claim 44, further comprising at least one of:
opening the sliding gate at the urging of an air pressure system; and
closing the sliding gate at the urging of the air pressure system.

46. The method according to claim 45, further comprising:
controlling the air pressure system by the identifier; and
synchronizing the air pressure system with the conveying apparatus.

47. The method according to claim 46, wherein the sliding gate is opened in the opening step in the conveying direction.

48. The method according to claim 47, wherein the sliding gate is opened in the opening step in accordance with a speed of the conveying apparatus.

49. The method according to claim 47, wherein the sliding gate is closed in the closing step at a high rate of speed in accordance with a speed of the conveying apparatus to prevent any article not bearing the characteristic from passing the sliding gate while the sliding gate is open.

50. The method according to claim 46, wherein the sliding gate is opened in the opening step in a direction opposite the conveying direction.

51. The method according to claim 50, wherein the sliding gate is opened in the opening step at a high rate of speed in accordance with a speed of the conveying apparatus.

52. The method according to claim 50, wherein the sliding gate is closed in the closing step at a speed of the conveying apparatus to prevent any article not bearing the characteristic from passing the sliding gate while the sliding gate is open.
